(19) United States
(12) Patent Application Publication
(10) Pub. No.: US 2009/0144626 A1
(43) Pub. Date: Jun. 4, 2009

(54) ENABLING AND EXERCISING CONTROL OVER SELECTED SOUNDS ASSOCIATED WITH INCOMING COMMUNICATIONS

(76) Inventors: Barry Appelman, McLean, VA (US); Brian D. Heikes, Ashburn, VA (US); W. Karl Renner, Great Falls, VA (US)

Correspondence Address: FISH & RICHARDSON P.C., P.O. BOX 1022, MINNEAPOLIS, MN, 55440-1022, US

(21) Appl. No.: 12/089,857

(22) PCT Filed: Oct. 11, 2006
(86) PCT No.: PCT/US2006/039504

§ 371 Date: Sep. 11, 2008

Related U.S. Application Data
(60) Provisional application No. 60/724,798, filed on Oct. 11, 2005.

(51) Int. Cl. G06F 3/048; G06F 15/16

(52) U.S. Cl. 715/727; 709/206

(57) ABSTRACT

An online identity may selectively control perceptibility of incoming sounds associated with electronic messages between online identities (FIG. 4, 400). A first online identity is provided with two or more sound control options to selectively control rendering of one or more sounds associated with electronic messaging to the first online identity from a second online identity, and two or more control sound options to selectively control rendering of one or more sounds associated with electronic messaging to the first online identity from a third online identity (405). The selected sound control options associated with electronic messaging from at least one of the online identities are stored (410) and one or more sounds from at least one of the second online identity or the third online identity are received (415). The perceptibility of sound to the first online identity is selectively controlled in accordance with a selected sound control option from the first online identity (420).

### CROSS REFERENCE TO RELATED APPLICATION

The application claims priority to U.S. Provisional Application No. 60/724,798, filed Oct. 11, 2005, and titled CONTROLLING PERCEPTION OF SELECTED INCOMING SOUNDS, which is hereby incorporated by reference in its entirety.

### TECHNICAL FIELD

This document relates to enabling and exercising control over sounds associated with incoming messages in response to a request from an online identity for whom the sounds may be made perceivable.

### BACKGROUND

A sound associated with a message sender may be made perceivable for a message recipient in response to a communication sent from the message sender to the message recipient. For example, when first and second online identities exchange electronic messages, such as instant messages or e-mail messages, sounds may be presented to the first and second online identities coincident with and corresponding to the exchanged messages. An online identity may generically control these and other sounds at their computer by adjusting the volume and mute controls of the computer.

### SUMMARY

In one general aspect, a method for exercising control over selected sounds associated with incoming communications between online identities includes providing a first online identity with two or more sound control options to selectively control rendering of one or more sounds associated with electronic messaging to the first online identity from a second online identity, and two or more control sound options to selectively control rendering of one or more sounds associated with electronic messaging to the first online identity from a third online identity. Selected sound control options associated with electronic messaging from at least one of the second online identity or the third online identity are stored and one or more sounds from at least one of the second online identity or the third online identity is/are received. The perceptibility of sound to the first online identity is selectively controlled in accordance with selected sound control options from the first online identity. The selected sound control options include an indication of a selected sound control option associated with communications from the second online identity and an indication of a selected sound control option associated with communications from the third online identity.

Implementations may include one or more of the following features. For example, the selected sound control option associated with communications from the second online identity may differ from the selected control option associated with communications with the online identity. The selected sound control option associated with communications from the second online identity may include a volume adjustment of a sound associated with the second online identity, include muting of a sound associated with the second online identity, substituting another sound for a sound previously associated with the second online identity, or modifying one or more physical characteristics of a sound associated with the second online identity. The one or more physical characteristics may include at least one of pitch, frequency, amplitude, waveform, intensity, or quality of a sound associated with the second online identity.

The selected sound control option associated with communications from the second online identity may include substituting a visual effect perceivable by the first online identity or a vibrating effect perceivable by the first online identity through a client device for a sound previously associated with the second online identity.

A host and/or client system may control a sound associated with the second online identity to selectively control perceptibility of sound to the first online identity in accordance with the selected sound control option from the first online identity.

The rendering of one or more sounds associated with electronic messaging to the first online identity may be responsive to receipt of a new message from at least one of the second online identity or the third online identity.

In another general aspect, a graphical user interface or system enables a first online identity to selectively control perceptibility of incoming sounds associated with electronic messages between online identities. The graphical user interface is configured to provide a first online identity with two or more sound control options to selectively control rendering of one or more sounds associated with electronic messaging to the first online identity from a second online identity and/or third online identity. The graphical user interface enables selected sound control options associated with electronic messaging from at least one of the second online identity and/or the third online identity to be stored.

Upon receipt of one or more sounds from at least one of the second online identity and/or the third online identity, the graphical user interface is configured to selectively control perceptibility of sound to the first online identity in accordance with a selected sound control option from the first online identity. The selected sound control options include an indication of a selected sound control option associated with communications from the second online identity and an indication of a selected sound control option associated with communications from the third online identity.

In another general aspect, a method for enabling an online identity to control perceptibility of selected incoming sounds includes presenting an interface to a first online identity, the interface being configured to enable the online first online identity to specify control over how an incoming sound will be made perceivable in association with future communications to the first online identity from a second online identity. An indication of the control specified by the first online identity is stored, and the control is applied to an inbound communication associated with the second online identity in order to affect perceptibility of an incoming sound associated with the inbound communication.

The interface that may be presented to the first online identity may enable the first online identity to specify controls over how an incoming sound will be made perceivable in association with future communications to the first online identity from a third online identity. The first online identity may be enabled to specify controls over how the incoming sound will be made perceivable in association with future communications to the first online identity from the third online identity by enabling the first online identity to specify individual controls for each of the second online identity and the third online identity. A sound to be rendered instead of the incoming sound associated with the inbound communication, a visual effect to be rendered instead of the incoming sound associated with the inbound communication, and/or a sound adjustment to be applied to the incoming sound associated with the inbound communication may be stored. The sound adjustment may include muting the incoming message or adjusting the volume of the incoming message. Alternatively, or additionally, a vibrating control effect to be rendered instead of the incoming sound associated with the inbound communication may be stored.

In another general aspect, a method for enabling and exercising control over selected sounds associated with incoming communications includes receiving an indication of a sound to be made perceivable to a first online identity in response to the first online identity communicating with at least a second online identity. An indication of a prior request by the first online identity to control rendering of the sound associated with the second online identity is accessed and perceptibility of the sound to the first online identity is controlled in accordance with the request.

Implementations of this aspect may include one or more of the following features. For example, the request to control rendering of the sound may be a request to mute the sound and controlling perceptibility of the sound may include muting the sound. The request to control rendering of the sound may be a request to make the sound perceivable, and controlling perceptibility of the sound may include making the sound perceivable. The request to control rendering of the sound may be a request to mute other sounds that are made perceivable at substantially the same time as the sound, and controlling perceptibility of the sound may include making the sound perceivable while affecting a volume of the other sounds. Affecting the volume may include muting the other sounds or the request to control rendering of the sound may be a request to control rendering of sounds to be made perceivable in association with a particular online identity. The perceptibility of the sound may be controlled by determining whether the second online identity is the particular online identity, and controlling perceptibility of the sound based on whether the second online identity is the particular online identity.

The perceptibility of the sound may be controlled based on whether the second online identity is the particular online identity and may include controlling perceptibility of the sound when the second online identity is the particular online identity. The perceptibility of the sound may be controlled based on whether the second online identity is the particular online identity and may include controlling perceptibility of the sound when the second online identity is not the particular online identity. The particular online identity may be selected from a contact list maintained by the first online identity. The contact list may be a list of online identities for whom online presence is monitored and that is used in association with an instant messaging system. The contact list may be a list of online identities for whom contact information is maintained and that is used in association with an email system.

The request to control rendering of the sound may be a request to control rendering of sounds that include particular content, and controlling perceptibility of the sound may include determining whether the sound includes the particular content, and controlling perceptibility of the sound based on whether the sound includes the particular content. The request to control rendering of sounds that include particular content may be a request to control rendering of sounds that include at least one of profanity, inappropriate content, objectionable content, or music. An indication of a request for the second online identity may be accessed to control rendering of the sound made by a third online identity on behalf of the first online identity. The third online identity may be a parent or an employer of the first online identity. An instant message or email message may be received from the second online identity. An indication of the sound to be made perceivable in association with the second online identity which is received may include receiving a sound that is rendered responsive to the receipt of the instant message or the email message from the second online identity.

In another general aspect, a computer program stored on a computer-readable medium may be executed to generate a graphical user interface on a display device for enabling control of perceptibility of selected incoming sounds. The graphical user interface includes an incoming sound control for generating a control affecting perceptibility of an incoming sound to be made perceivable in association with an inbound communication associated with a particular online identity when applied to the inbound communication, the control affecting a subset of sounds to be made perceivable in association with multiple online identities.

These general and specific aspects may be implemented using a system, a method, or a computer program, or any combination of systems, methods, and computer programs. The system, method, or computer program, or any combination thereof enables a user identity to selectively exercise control over selected sounds associated with incoming communications.

Other features will be apparent from the description and drawings, and from the claims.

### DESCRIPTION OF DRAWINGS

FIG. 1 is a block diagram of an exemplary networked computing environment.

FIG. 2 is an illustration of and interface for sending and receiving instant messages.

FIG. 3 is an illustration of an interface displaying a list of online identities for whom online presence information is made available for monitoring.

FIG. 4 is a flow chart of a process for controlling perceptibility of selected incoming sounds.

FIG. 5 is an illustration of an interface for identifying particular online identities from whom incoming sounds are muted.

FIG. 6 is an illustration of a modified version of the interface of FIG. 3 with an indication of selected online identities and groups thereof for which incoming sounds are muted.

FIG. 7 is a flow chart of a process for muting incoming sounds associated with selected online identities.

FIG. 8 is an illustration of a modified version of the interface of FIG. 3 showing activation of an option for muting incoming sounds associated with a selected one of the online identities for whom online presence information is monitored.

FIG. 9 is an illustration of an interface for identifying particular online identities from whom incoming sounds are made perceivable.

FIG. 10 is an illustration of a modified version of the interface of FIG. 3 with an indication of selected online identities from whom incoming sounds are made perceivable.

FIG. 11 is an illustration of an interface for identifying particular online identities from whom incoming sounds are modified.

FIG. 12 is a flow chart of a process for modifying incoming sounds associated with selected online identities.

FIG. 13 is an illustration of an interface for identifying particular online identities from whom incoming sounds are substituted with alternate incoming sounds.

FIG. 14 is a flow chart of a process for substituting incoming sounds associated with selected online identities with alternate or supplemental incoming sounds.

FIG. 15 is an exemplary table of sound control options for controlling incoming sounds.

FIG. 16 is a flow chart of a process for controlling perceptibility of selected incoming sounds.

Like reference symbols in the various drawings indicate like elements.

### DETAILED DESCRIPTION

Techniques are provided to provide an online identity with granular control over the perception of particular incoming sounds. The particular incoming sounds represent only a subset of all incoming sounds that may be made perceivable to the online identity. Controlling perception of a sound may include muting or switching the sound, making the sound perceivable to the online identity, or enhancing perception of the sound, such as, for example, by muting other sounds that may be made perceivable at the same time as the sound. For example, the online identity may request control over incoming sounds associated with particular online identities. The online identity may identify the particular online identities from a contact list that is maintained by the online identity. As another example, the online identity may request control of incoming sounds that include particular content, such as inappropriate or objectionable content. A parent or employer of the online identity may request control of perception of the incoming sounds on behalf of the online identity. Alternatively, or in addition, the incoming sounds may be selectively controlled by the online identity to have a reduced volume or soft tone, to be replaced with alternative sounds, or to generate a signal causing an online identity's device to vibrate or produce a non-audible indication in lieu of the incoming sound.

Providing an online identity with granular control over the perception of particular incoming sounds prevents the online identity from having to categorically control perception of all incoming sounds in a single manner. This may be particularly useful when the online identity desires to control perception of only a subset of the incoming sounds, rather than all of the incoming sounds. For example, some incoming sounds may provide valuable information to the online identity, while other incoming sounds may provide useless or undesirable information to the online identity. The online identity's granular control over the perception of the incoming sounds enables the user to perceive only those incoming sounds that provide valuable information to the online identity. In other words, the granular control may prevent the user from being distracted by useless or undesirable incoming sounds. The online identity may not desire to control perception of all of the incoming sounds to avoid the undesirable incoming sounds, because the online identity may desire to perceive the incoming sounds that provide the valuable information.

Moreover, a large number of incoming sounds may be slated for presentation to the online identity. Since the number of incoming sounds to be presented is large, presentation of one of the incoming sounds may interfere with the online identity's ability to correctly perceive others of the incoming sounds. The granular control enables the user to select which of the large number of incoming sounds should be presented, such that the selected incoming sounds may be fully and correctly perceived. The online identity may not desire to control perception of all of the incoming sounds, since some of the incoming sounds may be important or otherwise worthy of perception.

As an example, incoming sounds may be presented to an employee of a company as the employee is working on a report for his boss. Some of the incoming sounds may be associated with the boss and may be presented incident to electronic messages from the boss providing feedback on the report. In addition, others of the incoming sounds may be associated with a family member of the employee and may be presented incident to electronic messages from the family member that are unrelated to the report. The employee may decide that he needs to perceive the incoming sounds associated with the boss because those incoming sounds provide information regarding the report on which the employee is working. In addition, the employee may decide that the incoming sounds associated with the family member are distracting the employee from the report. Therefore, the employee may control perception of the incoming sounds associated with the family member while allowing the incoming sounds associated with the boss to be perceived.

As another example, multiple different incoming sounds associated with a first online identity may be presented to a second online identity. Some of the incoming sounds may be appropriate for the second online identity to perceive at any time, while others may only be appropriate for perception when the second online identity is at home. Accordingly, when the second online identity is at work, the second online identity may request to control perception of only the incoming sounds that are appropriate when the second online identity is at home, thereby allowing the remaining incoming sounds to be perceived.

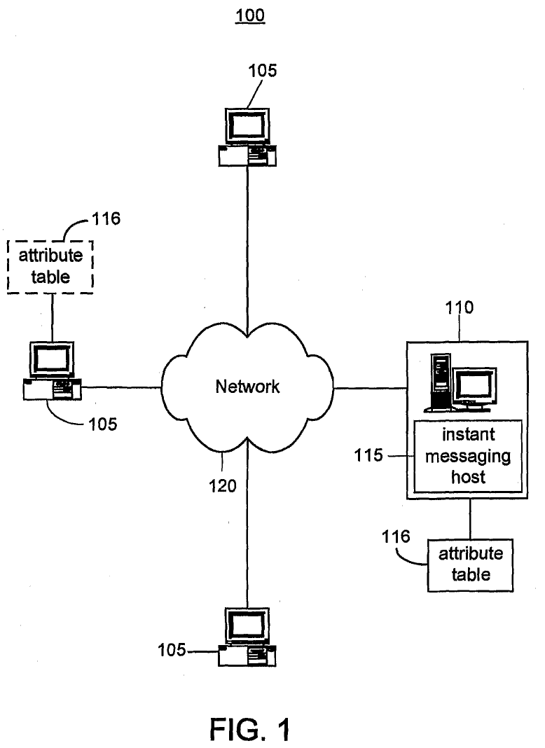

Referring to FIG. 1, an exemplary networked computing environment 100 supports communications between computer users. The computer users are distributed geographically and communicate using client systems 105. A host server 110 that includes an instant messaging host 115 may facilitate communications between the client systems 105. A network 120 interconnects the client systems 105 and the host server 110. Each of the client systems 105 and/or the host server 110 may include attribute tables 116 that define control options, such as sound control options for incoming messages, to be applied to electronic messaging between user identities.

Each of the client systems 105 and the host server 110 may be implemented using, for example, a general-purpose computer capable of responding to and executing instructions in a defined manner, a personal computer, a special-purpose computer, a workstation, a server, a device, a component, or other equipment or some combination thereof capable of responding to and executing instructions. The client systems 105 and the host server 110 may receive instructions from, for example, a software application, a program, a piece of code, a device, a computer, a computer system, or a combination thereof, which independently or collectively direct operations, as described herein. These instructions may take the form of one or more communications programs that facilitate communications between the users of the client systems 105. For instance, such communications programs may include e-mail programs, instant messaging (IM) programs, file transfer protocol (FTP) programs, and voice over internet protocol (VoIP) programs. The instructions may be embodied permanently or temporarily in any type of machine, component, equipment, storage medium, or propagated signal that is capable of being delivered to the client systems 105 or the host server 110.

Further, each of the client systems 105 and the host server 100 includes a communications interface (not shown) used by the communications programs to send communications through the network 120. The communications may include, for example, e-mail, audio data, video data, general binary data, or text data (e.g., data encoded in American Standard Code for Information Interchange (ASCII) format). The client systems 105 also may include one or more input devices, such as a keyboard, a mouse, a stylus, a camera, or a microphone, as well as one or more output devices, such as a monitor, a touch screen, speakers, or a printer.

The host server 110 facilitates some direct or indirect communications between the client systems 105. For example, the host server 110 may include an instant messaging host 115. The instant messaging host 115 may receive an instant message from one of the client systems 105 and may forward the message to another one of the client systems 105 that is used by a recipient of the instant message. A sound may be associated with the instant message that is received and forwarded by the instant messaging host 115. In some implementations, the instant messaging host 115 may determine if the recipient of the message has requested that perception of the sound be controlled for the recipient. If the sound is to be controlled, the instant messaging host 115 may control the perception of the sound for the recipient. In other implementations, one of the communications programs operating on the client system 105 used by the recipient may control perception of the sound as appropriate.

The client systems 105 and the host server 110 may be connected to the network 120 through various communication channels, such as a modem connected to a telephone line (using, for example, serial line internet protocol (SLIP) or point-to-point protocol (PPP)) or a direct internetwork connection (using, for example, transmission control protocol/internet protocol (TCP/IP)). The network 120 typically includes a series of portals interconnected through a coherent system. Examples of the network 120 include the internet, Wide Area Networks (WANs), Local Area Networks (LANs), analog or digital wired and wireless telephone networks (e.g., a Public Switched Telephone Network (PSTN), an Integrated Services Digital Network (ISDN), or a Digital Subscriber Line (xDSL)), or any other wired or wireless network. The network 120 may include multiple networks or subnetworks, each of which may include, for example, a wired or wireless data pathway.

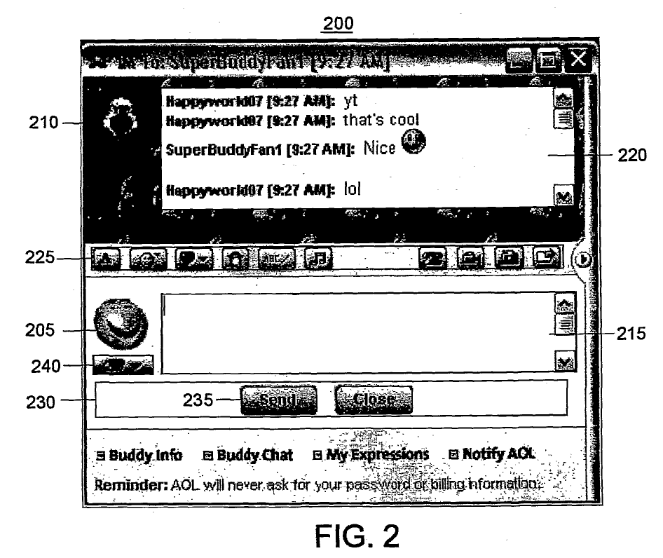

FIG. 2 illustrates and exemplary graphical user interface 200 for an instant messaging service capable of enabling an online identity to project an avatar for self-expression. The user interface 200 may be viewed by an online identity who is an instant message sender. In this particular example, the user's instant messaging communications program is configured to project an avatar associated with and used as an online identifier to one or more other online identities or groups of online identities (collectively, instant message recipients). After a sender of instant messages is notified that a recipient is present and available to participate in the communication of instant messages, the sender may use the interface 200 to exchange instant messages with the recipient.

The instant message sender projects a sender avatar 205 in an instant messaging communications session with an instant message recipient, e.g., SuperBuddyFan1, who projects a recipient avatar 210. A corresponding graphical user interface (not shown) is used by the instant message recipient SuperBuddyFan1. In this manner, the sender avatar 205 is visible in each of the sender's user interface and the recipient's user interface, as is the recipient avatar 210. The instant messaging communications session may be conducted simultaneously, near-simultaneously, or serially.

The interface 200 includes an instant message composition area 215 for composing instant message messages to be sent to the instant message recipient and a message history text box 220 for displaying a running transcript of the instant message communications session with the instant message recipient. Each of the messages sent to, or received from, the instant message recipient are listed in chronological order in the message history text box 220, each with an indication of the user who sent the message. The message history text box 220 optionally may include a time stamp for each of the messages sent.

The interface 200 also includes a set of feature controls 225 and a set of transmission controls 230. The feature controls 225 enable the user to change the size, foreground color, background color, style, and effects of the text entered in the message composition area 215. The feature controls 225 also may control features such as encryption, conversation logging, conversation forwarding to a different communications mode, and spell checking, among others. The set of transmission controls 230 includes a control 235 to trigger sending of the message that was typed into the instant message composition area 215. The interface 200 also includes a control 240 for modifying the appearance or behavior of the sender avatar 205.

Each of the sender avatar 205 and the recipient avatar 210 is a graphical image that represents an online identity in an instant message communications session. The sender avatar 205 may be animated in response to an instant message sent to the instant message recipient, and the recipient avatar 210 may be animated in response to an instant message sent by the instant message recipient. For example, the text of an instant message sent by the sender may trigger an animation of the sender avatar 205, and the text of an instant message sent by the instant message recipient to the sender may trigger an animation of the recipient avatar 210. Alternatively or additionally, the sender avatar 205 may be animated in response to an instant message sent from the instant message recipient, and the recipient avatar 210 may be animated in response to a message sent from the instant message sender. The animations of the avatars 205 and 210 may cause the avatars 205 and 210 to, under ordinary circumstances and without intervention, generate sounds that are audible to the user of the interface 200 and/or move, such as to shake or travel across a portion of the screen in a manner perceivable and noticeable by the recipient.

In addition, the sender avatar 205 or the recipient avatar 210 may be animated in direct response to a request from the sender or the recipient. An animation in one of the avatars 205 or 210 displayed on the instant messaging user interface 205 may cause an animation in the other avatar. The recipient avatar 210 may appear to respond to a mood of the sender communicated by the sender avatar 205, and vice versa. One of the avatars 205 or 210 may be animated in response to a detected idle period of a predetermined duration, or to reflect the weather at the geographic locations of the sender and the recipient, respectively. The sender avatar 205 also may be animated to reflect an aspect of the setting or the environment of the sender, an activity being performed by the sender, or a mood of the sender. Furthermore, the avatars 205 and 210 may be used to audibly verbalize content other than the text communicated between parties during a communications session.

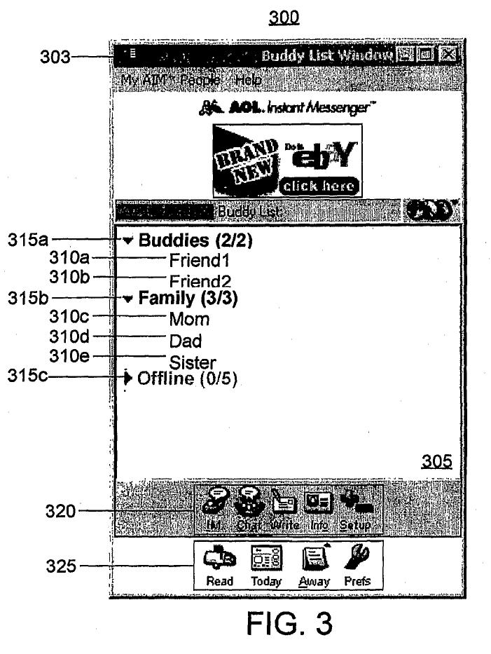

Referring to FIG. 3, a participant list interface 300 for a given user displays the online identifiers of other selected online identities of an instant messaging system for whom the given user is provided with online presence information. The other selected online identities form a participant list for the given user. Communications with one of the other selected online identities may be initiated through selection of the corresponding online identifier from the participant list. The other online identifiers may have been added to the participant list by the given user manually or automatically.

The participant list interface 300 includes a text box 305 that contains the participant list for the given user, who is identified by an identifier “AOLUser,” as indicated in the title bar 303 of the participant list interface 300. The participant list in the participant list interface 300 includes multiple identifiers 310a-310e. More particularly, the participant list includes the identifier “Friend1” 310a, the identifier “Friend2” 310b, the identifier “Mom” 310c, the identifier “Dad” 310d, and the identifier “Sister” 310e.

The identifiers within the participant list shown by participant list interface 300 are organized into multiple groups 315a-315c. Each identifier within the participant list is associated with at least one of the groups 315a-315c. The participant list includes a “Buddies” group 315a, a “Family” group 315b, and an “Offline” group 315c. The identifier 310a appears below the heading for the group 315a because the identifier 310a has been associated with the group 315a and the corresponding online identity is present, that is, logged into the instant messaging system and available to send and receive instant messages. The heading for each of the groups 315a and 315b indicates the number of online identities in the group currently logged into the instant messaging system (e.g., present), as well as the total number of online identities in the group. For example, the indication “(2/2)” located adjacent to the “Buddies” heading indicates that two out of the two members of the group 315a are logged into the instant messaging system for which the participant list interface 300 is displayed. Similarly, the heading for the “Offline” group 315c indicates the number of other online identities on the participant list that are not logged into the system (i.e., 0) and the total number of online identities on the participant list (i.e., 5). Typically, when online identities log into the instant messaging system, online identifiers are moved from the “Offline” group 315c to one of the other groups 315a or 315b.

The participant list interface 300 also includes controls 320 that enable the given user to communicate with the other selected online identities corresponding to the identifiers 310a-310e. For example, the given user may send instant messages, chat invitations, or e-mail messages to the communications identities referenced in the participant list through use of the controls 320. The controls 320 also enable the user to obtain information describing the other online identities, as well as to modify the set of other online identities referenced in the participant list interface 300.

The participant list interface 300 also includes controls 325 that enable the given user to access other information not directly related to sending and receiving instant messages. For example, the given user may use the controls to access e-mail messages or other special features of the instant messaging system. The given user also may use the controls 325 to modify preferences for the participant list interface 300.

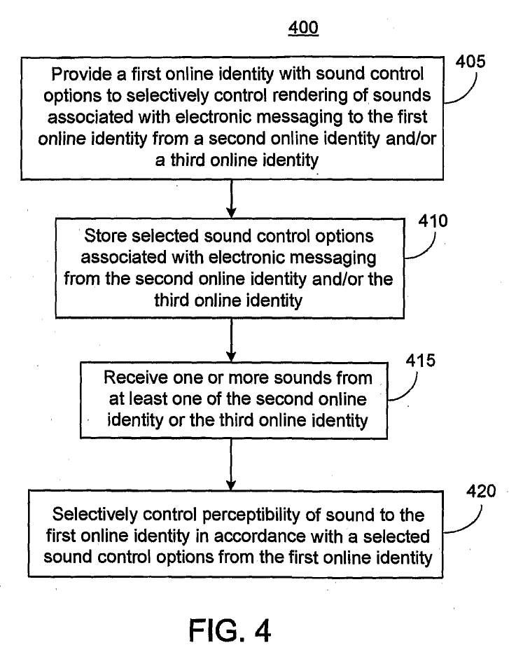

Referring to FIG. 4, a process 400 is used to exercise control over selected sounds associated with incoming communications between online identities. For example, a first online identity is provided (405) with control options, such as two or more sound control options, to selectively control rendering of one or more sounds associated with electronic messaging to the first online identity from a second online identity. The first online identity is also provided with control options to selectively control rendering of one or more sounds associated with electronic messaging to the first online identity from a third online identity (410). The selected sound control options associated with electronic messaging from at least one of the second online identity or the third online identity may be stored (415) and one or more sounds from at least one of the second online identity or the third online identity (420) is received by the first online identity. The perceptibility of sound to the first online identity is selectively controlled in accordance with a selected sound control options from the first online identity (425). For example, the selected sound control options may include an indication of a selected sound control option associated with communications from the second online identity and an indication of a selected sound control option associated with communications from the third online identity.

For example, the process 400 may be used to control perception of a subset of incoming sounds that are to be presented to an online identity in association with received instant messages. The incoming sounds for which perception is controlled may be those incoming sounds that are associated with particular senders of instant messages. The process 400 may be executed by an instant messaging host, such as the instant messaging host 115 of FIG. 1. Alternatively or additionally, the process 400 may be executed by a client system operated by an online identity for whom the incoming sounds may be made perceivable, such as one of the client systems 105 of FIG. 1. For example, a first client system, e.g., an online identity's work system, may execute process 400 to control the perception of sounds in a first, customizable manner and a second client system, e.g., an online identity's home system, may execute process 400 to control the perception of sounds in a second, customizable manner. However, for ease of discussion, the process 400 will be described as being performed by the instant messaging host.

The instant messaging host receives an indication of an incoming sound to be made perceivable in association with a first online identity. An incoming sound may be a sound to be presented to a second online identity that was not explicitly requested by the second online identity. For example, an incoming sound may be a sound that is rendered incident to receipt of an electronic message, such as an instant message or an email message, sent to the second online identity from the first online identity. In such a case, the second online identity did not request the incoming sound. Instead, the sound was provided to the second online identity by the first online identity with the electronic message.

The instant messaging host accesses an indication of a sound control option selected or requested by the second online identity to control rendering of the sound associated with the first online identity. For example, the second online identity may select a sound control option to control incoming sounds associated with a particular online identity. The particular online identity may be an online identity included in a contact list that is maintained by the second online identity. The contact list may be a list of online identities for whom online presence is monitored that is used in association with an instant messaging system, or a list of online identities for whom contact information is maintained that is used in association with an e-mail system. Alternatively or additionally, the second online identity may select a sound control option to control a subset of the incoming sounds associated with the particular online identity. As another example, the second online identity may select a sound control option indicating that perception of sounds including particular content is to be controlled. For example, the second online identity may request that perception of sounds that include profanity, otherwise inappropriate or objectionable content, or music be controlled. The request to control perception of the incoming sound may be a request to mute or modify or change altogether (e.g., substitute) the incoming sound, or to make the incoming sound perceivable, perhaps while muting other sounds. In some implementations, the request to control perception of selected incoming sounds may be generated by a third online identity on behalf of the second online identity. The third online identity may be, for example, a parent or an employer of the second online identity.

In typical implementations, the request may be accessed from a store of requests that is local to the system executing the process 400. Alternatively or additionally, the request may be accessed from a store that is external to the system executing the process 400. For example, in implementations where the process 400 is executed by a client system used by the second online identity to generate the request, the request may be accessed from a local store on the client system, or from the instant messaging host to which the request was transmitted after generation.

In one implementation, the request may apply only to the second online identity, for example, because the second online identity specified the request. Alternatively or additionally, the request may apply to multiple online identities associated with the second online identity. For example, the multiple online identities may represent online identities used by a single user. Alternatively, the multiple online identities may represent a group of users, such as the online identities that use a client system used by the second online identity.

The instant messaging host or client may control perception of the sound for the second online identity in accordance with a selected sound control option. If the request identified a particular online identity whose incoming sounds are controlled, the instant messaging host may determine whether the first online identity is the particular online identity, and perception of the incoming sound may be controlled accordingly. Similarly, if the request indicated that perception of incoming sounds including particular content should be controlled, the instant messaging host may determine whether the incoming sound includes the particular content, and may control perception of the incoming sound accordingly.

Controlling perception of the sound may include muting, modifying, or exchanging the sound, or making the sound perceivable to the second online identity. Alternatively or additionally, controlling the sound may include making the sound perceivable to the second online identity while muting other sounds being made perceivable to the second online identity when the incoming sound is to be made perceivable to the second online identity. For example, a volume of the sound may be increased or volumes of the other sounds may be decreased to enable the sound to be perceived over the other sounds. As another example, the sound and the other sounds may be ordered for presentation such that the sound is presented first and the other sounds are presented later without overlapping or otherwise interfering with the presentation of the sound. The manner in which perception of the sound is controlled may be indicated in the request generated by the second online identity.

The instant messaging host may control perception of the incoming sound by modifying the sound locally and then sending the modified incoming sound to the client system used by the second online identity. In such a case, the client system simply may make the incoming sound that is received from the instant messaging host perceivable to the second online identity. Alternatively, the instant messaging host may control perception of the incoming sound by providing the incoming sound to the client system with an indication of a manner in which perception of the incoming sound should be controlled. In such a case, the client system may control perception of the incoming sound for the second online identity as indicated by the instant messaging host.

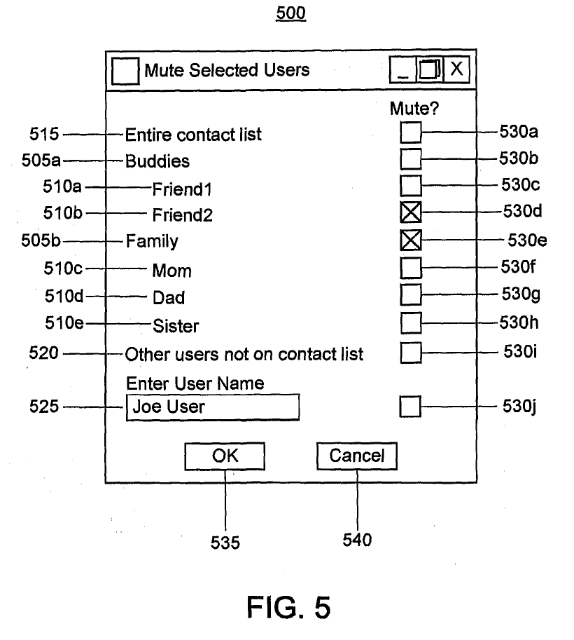

Referring to FIG. 5, an exemplary interface 500 enables an online identity to identify one or more online identities or groups of online identities from whom associated sounds are muted. For example, sounds associated with instant messages sent by the identified online identities or online identity groups to the online identity may be muted. The interface 500 includes several entity identifiers and group identifiers. For example, the interface 500 includes group identifiers 505a and 505b that identify groups of online identities whose incoming sounds may be muted. In addition, the interface 500 includes identifiers 510a-510e that identify particular online identities whose incoming sounds may be muted. Identifiers appearing below a group identifier represent online identities that are included in a online identity group represented by the group identifier. For example, the online identities represented by the identifiers 510a and 510b are included in an online identity group represented by the group identifier 505a.

The online identity groups and online identities identified by the group identifiers 505a-505b and the identifiers 510a-510e collectively may form a contact list that is maintained for the user of the interface 500. For example, the identified online identity groups and online identities may form a participant list of online identities for whom online presence information is monitored, such as the participant list displayed in the participant list interface 300 of FIG. 3. Alternatively or additionally, the identified online identity groups and online identities may form a list of online identities for whom contact information is maintained, such as an address book used in association with an e-mail system.

The interface also includes a list identifier 515 corresponding to the entire contact list represented by the group identifiers 505a-505b and the identifiers 510a-510e. Furthermore, an unlisted identifier 520 corresponds to all other online identities not included in the contact list represented by the group identifiers 505a-505b and the identifiers 510a-510e. The user also may specify an identifier of a single online identity not included in the represented contact list using a text field 525.

Each of the identifiers 505a-505b, 510a-510e, 515, and 520, and the identifier that may be specified in the text field 525 is associated with a corresponding checkbox 530a-530j included in the interface. Each of the checkboxes 530a-530j may be selected to mute incoming sounds associated with an online identity or online identity group represented by the identifier corresponding to the selected checkbox. For example, in the illustrated interface 500, the checkboxes 530d and 530e have been selected to mute incoming sounds associated with the online identity represented by the identifier 510b and the group of online identities identified by the group identifier 505b.

The interface also includes an accept button 535 (OK) and a cancel button 540. When the accept button 535 is selected, a request to mute incoming sounds associated with online identities and online identity groups corresponding to selected ones of the checkboxes 530a-530j may be submitted. When incoming sounds associated with the selected online identities are received, the incoming sounds may be muted in accordance with the request. Alternatively or additionally, a request to make perceivable incoming sounds associated with online identities and online identity groups associated with unselected ones of the checkboxes 530a-530j may be generated when the accept button 535 is selected. In addition, the interface 500 may be dismissed when the accept button 535 is selected. When the cancel button 540 is selected, the interface 500 is dismissed without first generating a request to mute or make perceivable selected incoming sounds.

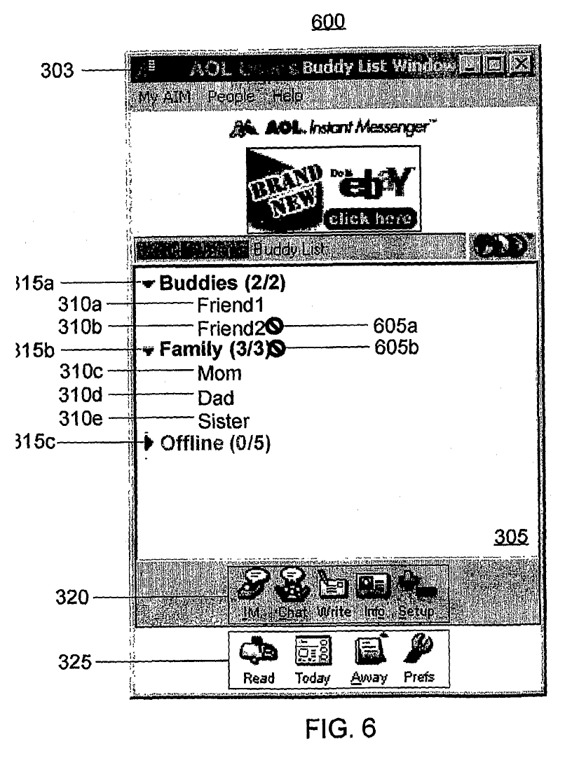

Referring to an interface 600 of FIG. 6, the interface 300 of FIG. 3 may be modified based, for example, on the use of the interface 500 of FIG. 5 to identify one or more online identities or online identity groups included in the displayed participant list whose incoming sounds are muted. The identified online identities or online identity groups may be displayed on the interface 600 with an indication that a request to mute the incoming sounds associated with the identified online identity or online identity groups has been submitted.

For example, the implementation of the interface 500 illustrated in FIG. 5 was used to request that incoming sounds associated with the online identity corresponding to the identifier 310b and with the online identities in the group 305b be muted. Consequently, the interface 600 includes icons 605a and 605b next to the identifier 310b and the group 305b, respectively. The icons 605a and 605b inform the user of the interface 600 that incoming sounds associated with the identifier 310b and the group 315b are muted. The lack of icons next to identifiers 310a and 310b, and groups 315a and 315c, indicates that incoming sounds associated with these other identifiers and the other groups are made perceivable.

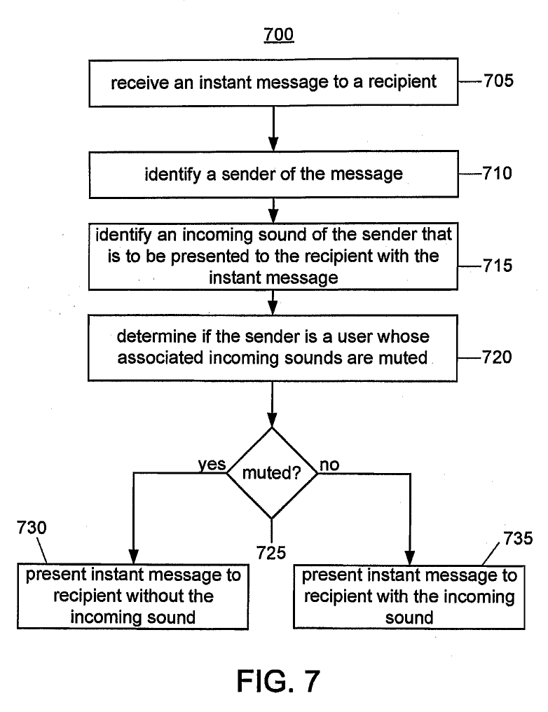

Referring to FIG. 7, a process 700 is used to control perception of an incoming sound that is associated with an instant message. Perception of the incoming sound may be controlled for a recipient of the instant message based on whether the recipient has requested that perception of incoming sounds associated with a sender of the message be controlled. The process 700 may be executed by an instant messaging host, such as the instant messaging host 115 of FIG. 1. Alternatively or additionally, the process 700 may be executed by a client system used by the recipient, such as one of the client systems 105 of FIG. 1. For ease of discussion, the process 700 will be described as being performed by the instant messaging host.

The instant messaging host receives an instant message directed to a recipient (705). The instant messaging host identifies a sender of the message (710) and an incoming sound associated with the sender that is to be presented to the recipient with the instant message (715). The instant messaging host may identify the sender from header information or other metadata associated with the received instant message. The incoming sound may be an audio file that is included in the instant message as an attachment. Since the incoming sound is included in an instant message sent by the sender, the incoming sound is associated with the sender.

The instant messaging host determines if the sender is an online identity whose associated incoming sounds are muted (720). Prior to execution of the process 700, the recipient, or a representative of the recipient, may have submitted a request to mute incoming sounds associated with a particular online identity. For example, the recipient may have used the interface 500 of FIG. 5 to generate the request. In such a case, the instant messaging host may determine whether the sender of the instant message is the particular online identity to determine whether the incoming sound is muted (725). If the sound is muted, then the instant messaging host signals for the instant message to be presented to the recipient without making the incoming sound perceivable to the recipient (730). If the sound is not to be muted, then the instant messaging host signals for the instant message to be presented to the recipient and for the incoming sound to be made perceivable to the recipient (735).

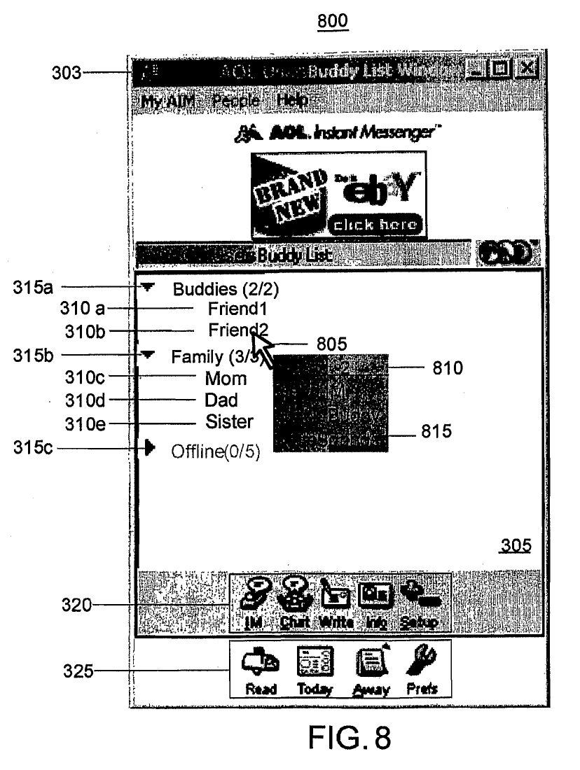

Referring to an interface 800 of FIG. 8, the participant list interface 300 of FIG. 3 is modified to enable a perceiving user to control or eliminate prior control exercised over perception of incoming sounds associated with online identities included in the displayed participant list. One of the identifiers 310a-310e may be selected to generate a request that perception of incoming sounds associated with a corresponding online identity be controlled. Alternatively or additionally, one of the groups 315a-315c may be selected to generate a request that perception of incoming sounds associated with online identities included in the selected group be controlled.

In one implementation, selecting one of the identifiers 310a-310e or one of the groups 315a-315c causes display of a menu including an option for generating a request to control perception of particular incoming sounds. For example, in the illustrated implementation, a pointing device 805 was used to select the identifier 310b, which caused a menu 810 to be displayed. The menu includes an option 815 for controlling incoming sounds and other features associated with the online identity corresponding to the identifier 310b for a user of the interface 800. For example, in the illustrated implementation, the option 815 enables muting incoming sounds associated with the online identity corresponding to the identifier 310b (Friend2) for the user of the interface 800. Additional control options are provided within menu 810, including an option to send an instant message to the identifier 310b and an option to block the identifier 310b from instant message communication with the user of the interface 800. When the option 815 is selected, a request to control perception of incoming sounds associated with the online identity corresponding to the identifier 310b is generated. When incoming sounds associated with the online identity corresponding to the identifier 310b are to be made perceivable to the user of the interface 800, perception of the incoming sounds is controlled in accordance with the generated request.

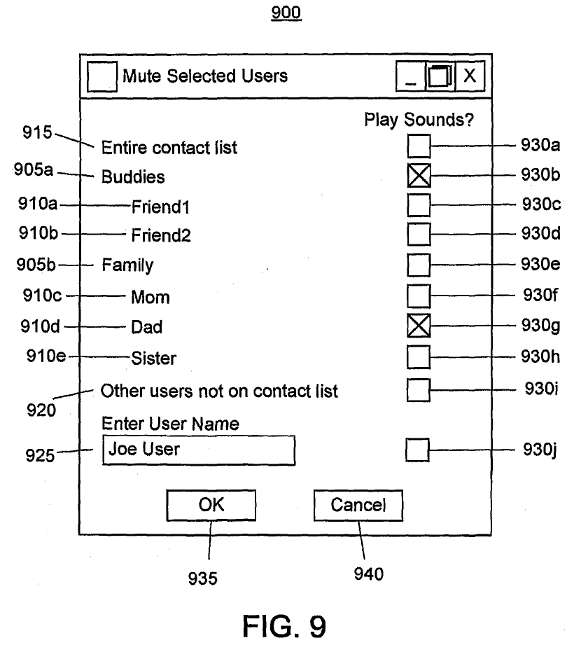

Referring to FIG. 9, an exemplary interface 900 is similar to the interface 500 of FIG. 5. For example, group identifiers 905a and 905b are similar to group identifiers 505a and 505b of FIG. 5, and identifiers 910a-910e are similar to identifiers 510a-510e of FIG. 5. In addition, a list identifier 915 is similar to the list identifier 515 of FIG. 5, and an unlisted identifier 920 is similar to the unlisted identifier 520 of FIG. 5. Furthermore, the text field 925 serves a similar purpose as the text field 525 of FIG. 5, and checkboxes 930a-930j are similar to checkboxes 530a-530j of FIG. 5.

However, instead of indicating that incoming sounds associated with corresponding online identities or online identity groups are to be muted when selected, the checkboxes 930a-930 indicate that incoming sounds associated with corresponding online identities or online identity groups are to be made perceivable to a user of the interface 900. For example, in the illustrated interface 900, the checkboxes 930b and 930g have been selected to indicate that incoming sounds associated with the group of online identities represented by the group identifier 905a and the online identity identified by the identifier 910d are to be made perceivable to the user of the interface 900. Incoming sounds associated with online identities and online identity groups corresponding to unselected ones of the checkboxes 930a-930j may be muted.

An accept button 935 generates a request to make incoming sounds associated with online identities and online identity groups corresponding to selected ones of the checkboxes 930a-930j perceivable to the user when selected. When incoming sounds associated with the selected online identities are received, the incoming sounds may be made perceivable in accordance with the request. Alternatively or additionally, a request to mute incoming sounds associated with online identities and online identity groups associated with unselected ones of the checkboxes 930a-930j may be generated when the accept button 935 is selected. When a cancel button 940 is selected, requests to mute or make perceivable incoming sounds may not be generated.

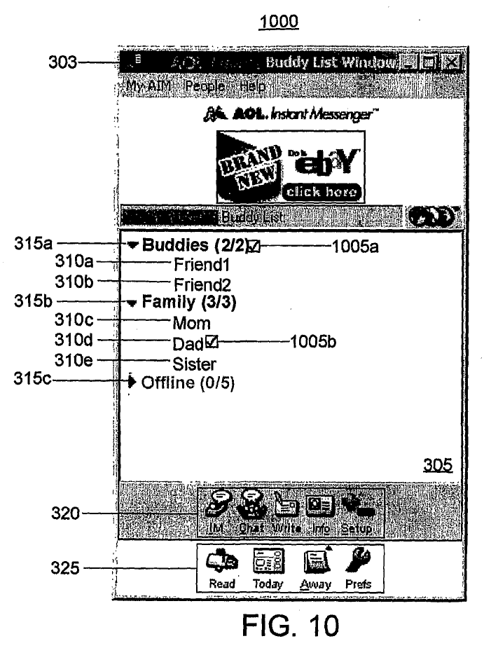

Referring to an interface 1000 of FIG. 10, the interface 300 of FIG. 3 may be modified based, for example, on the use of the interface 900 of FIG. 9 to identify one or more online identities or online identity groups included in the displayed participant list whose incoming sounds are made perceivable. The identified online identities or online identity groups may be displayed on the interface 1000 with an indication that a request to make perceivable the incoming sounds associated with the identified online identity or online identity groups has been submitted.

For example, the implementation of the interface 900 illustrated in FIG. 9 was used to request that incoming sounds associated with the online identities in the group 305a and with the online identity corresponding to the identifier 310d be made perceivable. Consequently, the interface 1000 includes icons 1005a and 1005b next to the group 305a and the identifier 310d, respectively. The icons 1005a and 1005b inform the user of the interface 1000 that the incoming sounds associated with the group 315a, which includes identifiers 310a and 310b, and identifier 310d are made perceivable. The lack of icons next to identifiers 310c and 310e indicates that incoming sounds associated with the other identifiers and the other groups are muted.

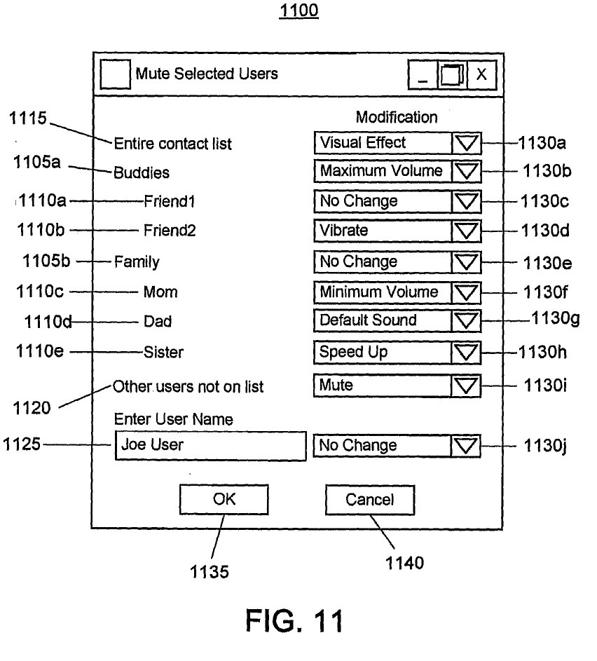

Referring to FIG. 11, an exemplary interface 1100 is similar to the interface 500 of FIG. 5. For example, group identifiers 1105a and 1105b are similar to group identifiers 505a and 505b of FIG. 5, and identifiers 11110a-1110e are similar to identifiers 510a-510e of FIG. 5. In addition, a list identifier 1115 is similar to the list identifier 515 of FIG. 5, and an unlisted identifier 1120 is similar to the unlisted identifier 520 of FIG. 5. Furthermore, the text field 1125 serves a similar purpose as the text field 525 of FIG. 5 However, instead of including checkboxes that are similar to checkboxes 530a-530j of FIG. 5, the interface 1100 includes selection lists 1130a-1130j. The selection lists 1130a-1130j may be used to select a modification to be applied to incoming sounds associated with corresponding online identities or groups before the incoming sounds are made perceivable to a user of the interface 1100. Each of the selection lists 1130a-1130j includes several options indicating available modifications that may be applied to the incoming sounds. For example, each of the selection lists 1130a-1130j may include options for presenting the corresponding incoming sounds at various volume levels, speeds, or lengths. In addition, each of the selection lists 1130a-1130j may include a default option signifying that no modification should be applied to the corresponding incoming sounds. Alternatively, or additionally, each of the selection lists 1130a-1130j may include an option that provides a vibrate mode, such as when the client system is a portable device, such as a personal digital assistant or a cell phone. Alternatively, or additionally, each of the selection lists 1130a-1130j may include an option that alters the sound, such as volume adjustment, while performing any one or more of the previous features. For example, a selection list may be equipped with a minimum volume and speed up option. The selection lists 1130a-1130j may alternatively, or additionally, include a feature that converts the sound into a visual signal, such as a silent alarm imparting only eye-catching movement to the screen or avatar.

In the illustrated interface 1100, an option for playing the incoming sounds associated with the group of online identities represented by the group identifier 1105a at a maximum volume has been selected from the selection list 1130b. In addition, an option for playing the corresponding incoming sounds at a minimum volume has been selected from the selection list 1130f, an option to speed up the corresponding incoming sounds has been selected from the selection list 1130h, and an option to mute the corresponding incoming sounds has been selected from the selection list 1130i. Incoming sounds associated with online identities and online identity groups corresponding to others of the selection lists 1130a-1130j in which the default option has been selected may be presented without modification.

An accept button (OK) 1135 generates a request to modify incoming sounds associated with online identities and online identity groups as indicated by options selected from corresponding ones of the selection lists 1130a-1130j. Incoming sounds associated with the online identities and online identity groups may be modified and made perceivable in accordance with the request. In addition, an indication of the modifications specified by the request may be presented on an interface that is similar to the interface 600 of FIG. 6 or the interface 1000 of FIG. 10. When a cancel button 1140 is selected, a request to modify incoming sounds may not be generated.

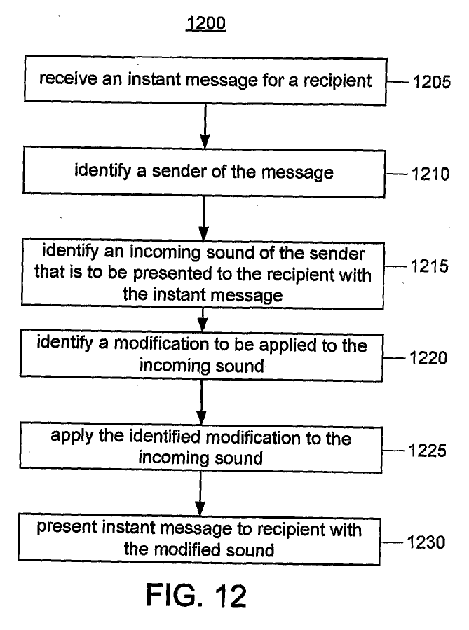

Referring to FIG. 12, a process 1200 is used to modify an incoming sound that is associated with an instant message before the message and the incoming sound are presented to a recipient of the message. The incoming sound may be modified for the recipient based on whether the recipient has requested modification of incoming sounds associated with a sender of the message. The process 1200 may be executed by an instant messaging host, such as the instant messaging host 115 of FIG. 1. Alternatively or additionally, the process 1200 may be executed by a client system used by the recipient, such as one of the client systems 105 of FIG. 1. For ease of discussion, the process 1200 will be described as being performed by the instant messaging host.

The instant messaging host receives an instant message directed to a recipient (1205). The instant messaging host identifies a sender of the message (1210) and an incoming sound associated with the sender that is to be presented to the recipient with the instant message (1215).

The instant messaging host also identifies a modification to be applied to the incoming sound (1220). Prior to execution of the process 1200, the recipient, or a representative of the recipient, may have submitted a request to modify incoming sounds associated with particular online identities. For example, the recipient may have used the interface 1100 of FIG. 11 to generate the request. In such a case, the instant messaging host may use the request to identify the modification to be applied to the incoming sound, based on whether the sender is one of the particular online identities. The instant messaging host then applies the identified modification to the incoming sound (1225), and the instant message is presented to the recipient with the modified sound (1230).

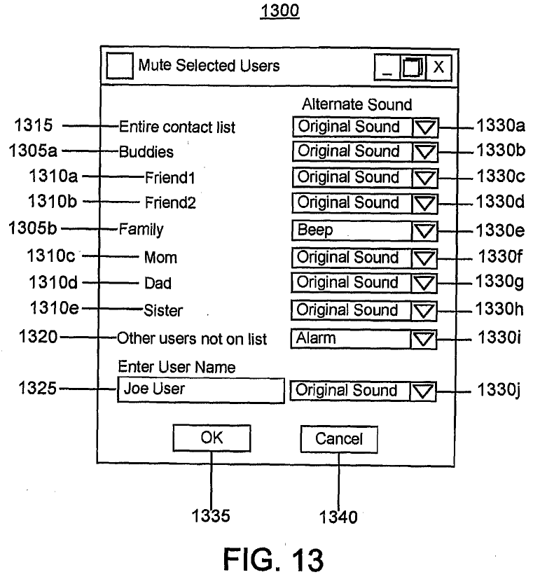

Referring to FIG. 13, an exemplary interface 1300 is similar to the interface 1100 of FIG. 11. For example, group identifiers 1305a and 1305b are similar to group identifiers 1105a and 1105b of FIG. 11, and identifiers 1310a-1310e are similar to identifiers 1110a-1110e of FIG. 11. In addition, a list identifier 1315 is similar to the list identifier 1115 of FIG. 11, and an unlisted identifier 1320 is similar to the unlisted identifier 1120 of FIG. 1. Furthermore, the text field 1325 serves a similar purpose as the text field 1125 of FIG. 11, and selection lists 1330a-1330j are similar to selection lists 1130a-1130j of FIG. 11.

However, instead of indicating manners in which incoming sounds associated with corresponding online identities or online identity groups are to be modified, the selection lists 1330a-1330j enable selection of alternate sounds to be substituted for the incoming sounds associated with corresponding online identities or online identity groups. Each of the selection lists 1330a-1330j includes several options indicating a set of available substitutions for the incoming sounds. In addition, each of the selection lists 1330a-1330j may include a default option signifying that the corresponding incoming sounds should not be substituted. For example, in the illustrated interface 1300, options from the selection lists 1330e and 1330i have been selected to indicate that incoming sounds associated with the group of online identities represented by the group identifier 1305b and the unlisted identifiers identified by the unlisted identifier 1320 are to be substituted with alternate sounds. Incoming sounds associated with online identities and online identity groups corresponding to others of the selection lists 1330a-1330j in which the default option has been selected may be presented without substitution. Additionally, or alternatively, the alternate sound may be a customizable sound designated by the user, such as a ring tone or other audio file saved at a client system or at the host, or may include a vibrate mode or other non-audible sound.

An accept button (OK) 1335 generates a request to substitute incoming sounds associated with online identities and online identity groups with alternate sounds that are identified by options selected from corresponding ones of the selection lists 1330a-1330j. Incoming sounds associated with the online identities and online identity groups may be substituted and made perceivable in accordance with the request. In addition, an indication of the substitutions specified by the request may be presented on an interface that is similar to the interface 600 of FIG. 6 or the interface 1000 of FIG. 10. When a cancel button 1340 is selected, a request to substitute incoming sounds with alternate sounds may not be generated.

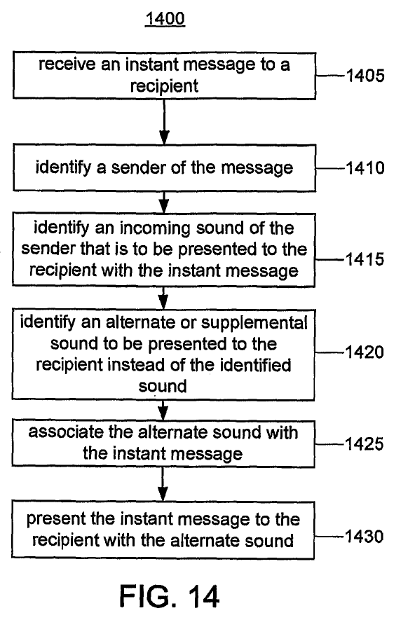

Referring to FIG. 14, a process 1400 is used to substitute an incoming sound that is associated with an instant message with an alternate sound before the message and the incoming sound are presented to a recipient of the message. The incoming sound may be substituted with the alternate sound based on whether the recipient has requested substitution of incoming sounds associated with a sender of the message with alternate sounds. The process 1400 may be executed by an instant messaging host, such as the instant messaging host 115 of FIG. 1. Alternatively or additionally, the process 1400 may be executed by a client system used by the recipient, such as one of the client systems 105 of FIG. 1. For ease of discussion, the process 1400 will be described as being performed by the instant messaging host.

The instant messaging host receives an instant message directed to a recipient (1405). The instant messaging host identifies a sender of the message (1410) and an incoming sound associated with the sender that is to be presented to the recipient with the instant message (1415).

The instant messaging host also identifies an alternate sound or feature, such as a beep, alarm, volume adjustment or a vibration mode, to be presented to the recipient instead of the incoming sound (1420). Prior to execution of the process 1400, the recipient, or a representative of the recipient, may have submitted a request to substitute incoming sounds associated with particular online identities with alternate sounds. For example, the recipient may have used the interface 1300 of FIG. 13 to generate the request. In such a case, the instant messaging host may use the request to identify the alternate sound with which to replace the incoming sound, based on whether the sender is one of the particular online identities. The instant messaging host then associates the alternate sound with the instant message (1425), and the instant message is presented to the recipient with the alternate sound (1430) or feature.

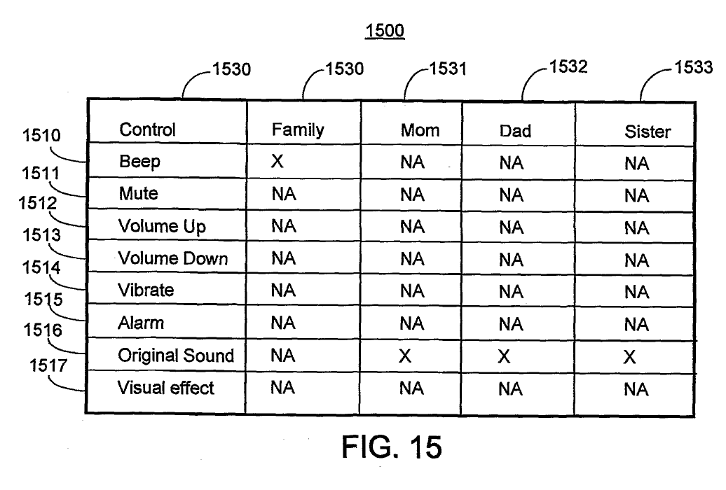

FIG. 15 is an exemplary look-up table 1500 for designated sound control options for controlling incoming sounds, e.g., such as alternate or supplemental sounds to be presented to the recipient. For example, an incoming sound may be substituted, played as intended, modified, or even supplemented in accordance with any of the foregoing control processes. Various sound control options 1510-1517 are listed for a buddy group 1530 and the contacts 1531-1533 associated with the buddy group 1530. Upon selecting a control option for a particular buddy group 1530 and/or contact, the recipient user identity is able to designate a desired sound control option to be applied each time an incoming message is received for the buddy group 1530, e.g., the “Beep” designated with an “X” is assigned to each of the contacts in the buddy group 1530. In addition, or alternatively, the individual contacts 1531-1533 may include separate or supplemental sound control options to be applied to any perceived, incoming sounds. If both a buddy group 1530 and individual contacts 1531-1533 are selected, the system may be configured to apply only the selected control option for the buddy group, the individual contact, or both. For example, the recipient user identity may selectively control options for a buddy group, e.g., Family 1530, and thereby control each of the incoming sounds in manner supplemental to, or in replace of individual control options selected at a lower, hierarchical level, e.g., individual contacts 1531-1533.

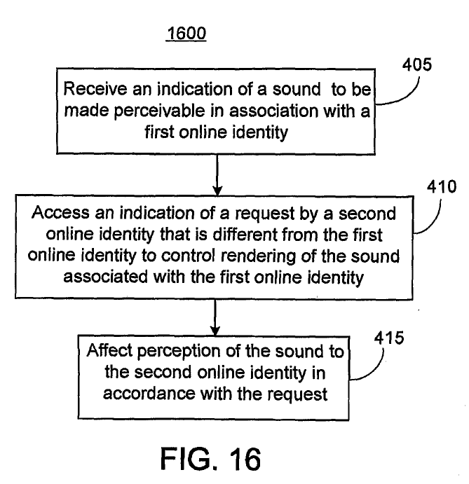

Referring to FIG. 16, a process 1600 is used to control perception of a subset of incoming sounds. For example, the process 1600 may be used to control perception of a subset of incoming sounds that are to be presented to an online identity in association with received instant messages. The incoming sounds whose perception is controlled may be those incoming sounds that are associated with particular senders of instant messages. The process 1600 may be executed by an instant messaging host, such as the instant messaging host 115 of FIG. 1. Alternatively or additionally, the process 1600 may be executed by a client system operated by an online identity for whom the incoming sounds may be made perceivable, such as one of the client systems 105 of FIG. 1. For example, a first client system, e.g., an online identity's work system, may execute process 1600 to control the perception of sounds in a first, customizable manner and a second client system, e.g., an online identity's home system, may execute process 1600 to control the perception of sounds in a second, customizable manner. However, for ease of discussion, the process 1600 will be described as being performed by the instant messaging host.

The instant messaging host receives an indication of an incoming sound to be made perceivable in association with a first online identity (1605). An incoming sound may be a sound to be presented to a second online identity that was not explicitly requested by the second online identity. For example, an incoming sound may be a sound that is rendered incident to receipt of an electronic message, such as an instant message or an email message, sent to the second online identity from the first online identity. In such a case, the second online identity did not request the incoming sound. Instead, the sound was provided to the second online identity by the first online identity with the electronic message.

The instant messaging host accesses an indication of a request by a second online identity to control rendering of the sound associated with the first online identity (1610). For example, the second online identity may generate a request to control incoming sounds associated with a particular online identity. The particular online identity may be an online identity included in a contact list that is maintained by the second online identity. The contact list may be a list of online identities for whom online presence is monitored that is used in association with an instant messaging system, or a list of online identities for whom contact information is maintained that is used in association with an e-mail system. Alternatively or additionally, the second online identity may generate a request to control a subset of the incoming sounds associated with the particular online identity. As another example, the second online identity may generate a request indicating that perception of sounds including particular content be controlled. For example, the second online identity may request that perception of sounds that include profanity, otherwise inappropriate or objectionable content, or music be controlled. The request to control perception of the incoming sound may be a request to mute or modify or change altogether (e.g., substitute) the incoming sound or to make the incoming sound perceivable, perhaps while muting other sounds being made perceivable. In some implementations, the request to control perception of selected incoming sounds may be generated by a third online identity on behalf of the second online identity. The third online identity may be, for example, a parent or an employer of the second online identity.

In typical implementations, the request may be accessed from a store of requests that is local to the system executing the process 1600. Alternatively or additionally, the request may be accessed from a store that is external to the system executing the process 1600. For example, in implementations where the process 1600 is executed by a client system used by the second online identity to generate the request, the request may be accessed from a local store on the client system, or from the instant messaging host to which the request was transmitted after generation.

In one implementation, the request may apply only to the second online identity, for example, because the second online identity specified the request. Alternatively or additionally, the request may apply to multiple online identities associated with the second online identity. For example, the multiple online identities may represent online identities used by a single user. Alternatively, the multiple online identities may represent a group of users, such as the online identities that use a client system used by the second online identity.

The instant messaging host then controls perception of the sound for the second online identity in accordance with the request (1615). If the request identified a particular online identity whose incoming sounds are controlled, the instant messaging host may determine whether the first online identity is the particular online identity, and perception of the incoming sound may be controlled accordingly. Similarly, if the request indicated that perception of incoming sounds including particular content should be controlled, the instant messaging host may determine whether the incoming sound includes the particular content, and may control perception of the incoming sound accordingly.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

1. A method for exercising control over selected sounds associated with incoming communications between online identities, the method comprising:
providing a first online identity with two or more sound control options to selectively control rendering of one or more sounds associated with electronic messaging to the first online identity from a second online identity;
providing the first online identity with two or more control sound options to selectively control rendering of one or more sounds associated with electronic messaging to the first online identity from a third online identity;
storing selected sound control options associated with electronic messaging from at least one of the second online identity or the third online identity;
receiving one or more sounds from at least one of the second online identity or the third online identity; and
selectively controlling perceptibility of sound to the first online identity in accordance with a selected sound control option from the first online identity, wherein the selected sound control options include an indication of a selected sound control option associated with communications from the second online identity and an indication of a selected sound control option associated with communications from the third online identity.

2. The method of claim 1, wherein the selected sound control option associated with communications from the second online identity is different than the selected control option associated with communications with the online identity.

3. The method of claim 1, wherein the selected sound control option associated with communications from the second online identity includes a volume adjustment of a sound associated with the second online identity.

4. The method of claim 1, wherein the selected sound control option associated with communications from the second online identity includes muting of a sound associated with the second online identity.

5. The method of claim 1, wherein the selected sound control option associated with communications from the second online identity includes substituting another sound for a sound previously associated with the second online identity.

6. The method of claim 1, wherein the selected sound control option associated with communications from the second online identity includes modifying one or more physical characteristics of a sound associated with the second online identity.

7. The method of claim 6, wherein the one or more physical characteristics includes at least one of pitch, intensity, or quality of a sound associated with the second online identity.

8. The method of claim 6, wherein the one or more physical characteristics includes at least one of frequency, amplitude, or waveform.

9. The method of claim 1, wherein the selected sound control option associated with communications from the second online identity includes substituting a visual effect perceivable by the first online identity for a sound previously associated with the second online identity.

10. The method of claim 1, wherein the selected sound control option associated with communications from the second online identity includes substituting a vibrating effect perceivable by the first online identity through a client device, for a sound previously associated with the second online identity.

11. The method of claim 1, wherein selectively controlling perceptibility of sound to the first online identity in accordance with a selected sound control option from the first online identity comprises a host controlling a sound associated with the second online identity in accordance with the request from the first online identity.

12. The method of claim 1, wherein selectively controlling perceptibility of sound to the first online identity in accordance with a selected sound control option from the first online identity comprises a client system of the first online identity controlling a sound associated with the second online identity in accordance with the request from the first online identity.

13. The method of claim 1, wherein rendering of one or more sounds associated with electronic messaging to the first online identity is responsive to receipt of a new message from at least one of the second online identity or the third online identity.

14. A graphical user interface enabling a first online identity to selectively control perceptibility of incoming sounds associated with electronic messages between online identities, the graphical user interface comprising:
means for providing a first online identity with two or more sound control options to selectively control rendering of one or more sounds associated with electronic messaging to the first online identity from a second online identity;
means for providing the first online identity with two or more control sound options to selectively control rendering of one or more sounds associated with electronic messaging to the first online identity to a third online identity;
means for storing selected sound control options associated with electronic messaging from at least one of the second online identity or the third online identity;
means for receiving one or more sounds from at least one of the second online identity or the third online identity; and
means for selectively controlling perceptibility of sound to the first online identity in accordance with a selected sound control options from the first online identity, wherein the selected sound control options include an indication of a selected sound control option associated with communications from the second online identity and an indication of a selected sound control option associated with communications from the third online identity.

15. A method for enabling an online identity to control perceptibility of selected incoming sounds, the method comprising:
presenting an interface to a first online identity, the interface being configured to enable the online first online identity to specify control over how an incoming sound will be made perceivable in association with future communications to the first online identity from a second online identity;
receiving an indication of the control specified by the first online identity through manipulation of the interface by the first online identity;
storing the indication of the control in association with the second online identity; and
applying the control to an inbound communication associated with the second online identity in order to affect perceptibility of an incoming sound associated with the inbound communication.

16. The method of claim 1, wherein presenting the interface to the first online identity, comprises enabling the first online identity to specify controls over how an incoming sound will be made perceivable in association with future communications to the first online identity from a third online identity.

17. The method of claim 2, wherein enabling the first online identity to specify controls over how the incoming sound will be made perceivable in association with future communications to the first online identity from the third online identity comprises enabling the first online identity to specify individual controls for each of the second online identity and the third online identity.

18. The method of claim 1, wherein storing the indication of the control in association with the second online identity comprises storing a sound to be rendered instead of the incoming sound associated with the inbound communication.

19. The method of claim 1, wherein storing the indication of the control in association with the second online identity comprises storing a visual effect to be rendered instead of the incoming sound associated with the inbound communication.

20. The method of claim 1, wherein storing the indication of the control in association with the second online identity comprises storing a sound adjustment to be applied to the incoming sound associated with the inbound communication.

21. The method of claim 1, wherein the sound adjustment comprises muting the incoming message.

22. The method of claim 21, wherein the sound adjustment comprises adjusting the volume of the incoming message.

23. The method of claim 1, wherein storing the indication of the control in association with the second online identity comprises storing a vibrating control effect to be rendered instead of the incoming sound associated with the inbound communication.

24. A method for enabling and exercising control over selected sounds associated with incoming communications, the method comprising:
receiving an indication of a sound to be made perceivable in association with a first online identity in response to the first online identity communicating with at least a second online identity;
accessing an indication of a prior request by the second online identity to control rendering of the sound associated with the first online identity, the request affecting a subset of sounds to be made perceivable in association with multiple online identities; and
controlling perceptibility of the sound to the second online identity in accordance with the request.

25. The method of claim 24 wherein:
the request to control rendering of the sound is a request to mute the sound; and
controlling perceptibility of the sound comprises muting the sound.

26. The method of claim 24 wherein:
the request to control rendering of the sound is a request to make the sound perceivable; and
controlling perceptibility of the sound comprises making the sound perceivable.

27. The method of claim 24 wherein:
the request to control rendering of the sound is a request to mute other sounds that are made perceivable at substantially the same time as the sound; and
controlling perceptibility of the sound comprises making the sound perceivable while affecting a volume of the other sounds.

28. The method of claim 27, wherein affecting the volume comprises muting the other sounds.

29. The method of claim 24 wherein:
the request to control rendering of the sound is a request to control rendering of sounds to be made perceivable in association with a particular online identity; and
controlling perceptibility of the sound comprises:
determining whether the first online identity is the particular online identity; and
controlling perceptibility of the sound based on whether the first online identity is the particular online identity.

30. The method of claim 29 wherein controlling perceptibility of the sound based on whether the first online identity is the particular online identity comprises controlling perceptibility of the sound when the first online identity is the particular online identity.

31. The method of claim 29 wherein controlling perceptibility of the sound based on whether the first online identity is the particular online identity comprises controlling perceptibility of the sound when the first online identity is not the particular online identity.

32. The method of claim 29, further comprising selecting the particular online identity from a contact list maintained by the second online identity.

33. The method of claim 32 wherein the contact list is a list of online identities for whom online presence is monitored and that is used in association with an instant messaging system.

34. The method of claim 32 wherein the contact list is a list of online identities for whom contact information is maintained and that is used in association with an email system.

35. The method of claim 24 wherein:
the request to control rendering of the sound is a request to control rendering of sounds that include particular content; and
controlling perceptibility of the sound comprises:
determining whether the sound includes the particular content; and
controlling perceptibility of the sound based on whether the sound includes the particular content.

36. The method of claim 24 wherein the request to control rendering of sounds that include particular content is a request to control rendering of sounds that include at least one of profanity, inappropriate content, objectionable content, or music.

37. The method of claim 24 wherein accessing an indication of a request to control rendering of the sound made by the second online identity comprises accessing an indication of a request for the second online identity to control rendering of the sound made by a third online identity on behalf of the second online identity.

38. The method of claim 37 wherein the third online identity is a parent or an employer of the second online identity.

39. The method of claim 24, further comprising receiving an instant message from the first online identity, wherein receiving an indication of the sound to be made perceivable in association with the first online identity comprises receiving a sound that is rendered responsive to the receipt of the email message from the first online identity.

40. The method of claim 24 further comprising receiving an email message from the first online identity, wherein receiving an indication of the sound to be made perceivable in association with the first online identity comprises receiving a sound that is rendered responsive to the receipt of the email message from the first online identity.

41. A computer program stored on a computer-readable medium that, when executed, generates a graphical user interface on a display device for enabling control of perceptibility of selected incoming sounds, the graphical user interface comprising:
an incoming sound control for generating a control affecting perceptibility of an incoming sound to be made perceivable in association with an inbound communication associated with a particular online identity when applied to the inbound communication, the control affecting a subset of sounds to be made perceivable in association with multiple online identities.
